(19) United States
(12) Patent Application Publication
(10) Pub. No.: US 2024/0306525 A1
(43) Pub. Date: Sep. 19, 2024

(54) DOWN FORCE CONTROL IN AN AGRICULTURAL IMPLEMENT

(71) Applicant: Väderstad Holding AB, Väderstad (SE)

(72) Inventors: Jakob LINDBERG, Linköping (SE); Oskar GUNNARSSON, Mjölby (SE)

(73) Assignee: Väderstad Holding AB, Väderstad (SE)

(21) Appl. No.: 18/576,511

(22) PCT Filed: Jun. 30, 2022
(86) PCT No.: PCT/EP2022/068016

§ 371 Date: Jan. 4, 2024

(30) Foreign Application Priority Data
Jul. 5, 2021 (SE) 2150871-8

(51) Int. Cl. A01B 63/00; A01B 63/111; A01B 63/32; F15B 15/14

(52) U.S. Cl. CPC A01B 63/008; F15B 15/1447; A01B 63/111; A01B 63/32

(57) ABSTRACT

An agricultural implement includes ground engaging tools, connected to an attachment frame via a linkage arrangement and a fluid control system. For each ground engaging tool there is a linear actuator to provide a supplemental down force to the ground engaging tool via the linkage arrangement. The linear actuators are adapted so that the same relation between the rod chamber control pressure and the cap chamber control pressure causes first linear actuators to provide a first supplemental down force, and second linear actuators to provide a larger second supplemental down force. This enables a higher supplemental down force to be applied to row units behind the tractor wheels, although the fluid control system supplies the same relation between the rod and cap chamber control pressures to all linear actuators.

### TECHNICAL FIELD

The present disclosure relates generally to control of the down force exerted towards the ground by ground engaging tools, such as e.g. row units, in an agricultural implement, such as e.g. an agricultural planter.

### BACKGROUND

Agricultural implements are often arranged with ground engaging tools that work the ground. For example, an agricultural planter normally comprises a number of row units that put seed into the ground as the machine moves over a field. Each row unit comprises a furrow opener that cuts a furrow in the ground into which seed is deposited before being covered. The agricultural planter may comprise one or more depth gauges that controls the depth to which the furrow openers cut the furrow.

The row units must have sufficient weight to force the furrow opener fully into the soil to the desired depth. More weight is needed for firmer soils. Since row units often do not have sufficient weight to fully penetrate the furrow opener into the soil, agricultural planters are typically provided with a supplemental down force system. Such a supplemental down force system may simply be a mechanical spring, but it may also comprise hydraulic or pneumatic linear actuators that provide the supplemental down force. The amount of supplemental down force is typically controlled by regulating the relation between the rod chamber control pressure and the cap chamber control pressure supplied to the linear actuators, which creates a net force on the piston in the linear actuators.

Agricultural planters generally have the same supplemental down force provided to all row units. However, since not all row units are operating in the same soil conditions, it is desirable to enable different supplemental down forces to be provided to different row units.

EP2554037 describes a supplemental down force system for an agricultural implement such as a row crop planter. In EP2554037, the row units are grouped into two or more groups, and there is separate control of the linear actuators in each group. Each row unit is equipped with a load sensor, and the input from these load sensors is used to group the row units into groups requiring a similar supplemental down force. U.S. Pat. No. 10,238,024 describes another supplemental down force system for a ground working implement, where there is individual control of each linear actuator.

### Problems with the Prior Art

Individual control of hydraulic or pneumatic linear actuators is expensive, since a complicated circuit is required to enable an individually controlled supply of fluid to a plurality of linear actuators. EP2554037 has addressed this problem by grouping the row units into two or more groups, but the separate control of the linear actuators in each group is still both complicated and expensive.

There is thus a need for a simpler method for controlling the down force exerted towards the ground by the ground engaging tools in an agricultural implement.

### SUMMARY

The above described problem is addressed by the claimed agricultural implement. The agricultural implement may comprise: an attachment frame; a plurality of ground engaging tools, each connected to the attachment frame via a linkage arrangement; a plurality of linear actuators, each comprising a barrel, divided into a rod chamber and a cap chamber by a piston with a connected piston rod extending into the rod chamber, the piston having a rod chamber piston area and a cap chamber piston area; and a fluid control system. Each linear actuator may be arranged to control the pivoting of one of the linkage arrangements, so that, for each ground engaging tool, there is a linear actuator arranged to provide a supplemental down force to the ground engaging tool via the linkage arrangement. The fluid control system may be arranged to control the size of the supplemental down force provided by each of the plurality of linear actuators by regulating the relation between a rod chamber control pressure supplied to the rod chamber and a cap chamber control pressure supplied to the cap chamber, creating a net force on the piston. The plurality of linear actuators may comprise first linear actuators and second linear actuators, adapted so that the same relation between the rod chamber control pressure and the cap chamber control pressure causes each first linear actuator to provide a first supplemental down force to its ground engaging tool, and each second linear actuator to provide a second supplemental down force to its ground engaging tool, where the second supplemental down force is substantially larger than the first.

The above described problem is further addressed by the claimed method for down force control in an agricultural implement. The method may comprise: connecting a plurality of ground engaging tools to the attachment frame of an agricultural implement via a linkage arrangement for each ground engaging tool; for each ground engaging tool, arranging a linear actuator to control the pivoting of the linkage arrangement, so that, for each ground engaging tool, there is a linear actuator arranged to provide a supplemental down force to the ground engaging tool via the linkage arrangement, where each linear actuator comprises a barrel, divided into a rod chamber and a cap chamber by a piston with a connected piston rod extending into the rod chamber, the piston having a rod chamber piston area and a cap chamber piston area; arranging a fluid control system to control the size of the supplemental down force in each of the plurality of linear actuators by regulating the relation between a rod chamber control pressure supplied to the rod chamber and a cap chamber control pressure supplied to the cap chamber, creating a net force on the piston; and arranging the linear actuators to comprise first linear actuators and second linear actuators, adapted so that the same relation between the rod chamber control pressure and the cap chamber control pressure causes each first linear actuator to provide a first supplemental down force to its ground engaging tool, and each second linear actuator to provide a second supplemental down force to its ground engaging tool, where the second supplemental down force is substantially larger than the first.

This enables different ground engaging tools to exert different down forces towards the ground, using a fluid control system that supplies the same relation between the rod chamber control pressure and the cap chamber control pressure to all linear actuators.

In embodiments, the ratio between the cap chamber piston area and the rod chamber piston area in the second linear actuators is substantially different from the ratio between the cap chamber piston area and the rod chamber piston area in the first linear actuators.

In embodiments, the diameter of the barrel in the first linear actuators is substantially different from the diameter of the barrel in the second linear actuators. This is one simple way of ensuring that the ratio between the cap chamber piston area and the rod chamber piston area is different in the second linear actuators than in the first linear actuators. The diameter of the barrel in the second linear actuators may e.g. be substantially larger than the diameter of the barrel in the first linear actuators.

In embodiments, the diameter of the piston rod in the second linear actuators is substantially different from the diameter of the piston rod in the first linear actuators. This is another simple way of ensuring that the ratio between the cap chamber piston area and the rod chamber piston area is different in the second linear actuators than in the first linear actuators. The diameter of the piston rod in the second linear actuators may e.g. be substantially smaller than the diameter of the piston rod in the first linear actuators.

In embodiments, the second linear actuators are arranged in positions where a substantially higher supplemental down force is desired, such as in positions that are expected to be located behind wheels of a vehicle towing the agricultural implement.

This enables modification of the agricultural implement by simply moving the ground engaging tools and their associated linear actuators, or even just the linear actuators, to new positions on the agricultural implement.

Since the same relation between the rod chamber control pressure and the cap chamber control pressure is supplied to all linear actuators, any linear actuator can be connected in any position. The farmer simply needs to ascertain that the second linear actuators are mounted behind the tractor wheels, in order to enable a higher down force to be applied to the ground engaging tools behind the tractor wheels.

In embodiments, the agricultural implement is an agricultural planter, and the ground engaging tools are row units.

In this application, the term “fluid” comprises both gas and liquids.

In this application, the term “agricultural implement” means any type of implement that may be used for agriculture. It may be a vehicle comprising its own driving means, or it may be an implement intended to be towed or carried by a vehicle such as e.g. a tractor.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 schematically illustrates the down force distribution in a prior art agricultural implement, where the same supplemental down force is provided to all ground engaging tools.

FIG. 2 schematically illustrates the down force distribution in an agricultural implement in accordance with one or more embodiments described herein.

FIG. 3 schematically illustrates an agricultural implement comprising an attachment frame and a plurality of ground engaging tools, in accordance with one or more embodiments described herein.

FIG. 4 illustrates an example of a ground engaging tool and a linkage arrangement, in accordance with one or more embodiments described herein.

FIGS. 5a-b schematically illustrate different embodiments of linear actuators, in accordance with one or more embodiments described herein.

FIG. 6 schematically illustrates a method for down force control in an agricultural implement, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION

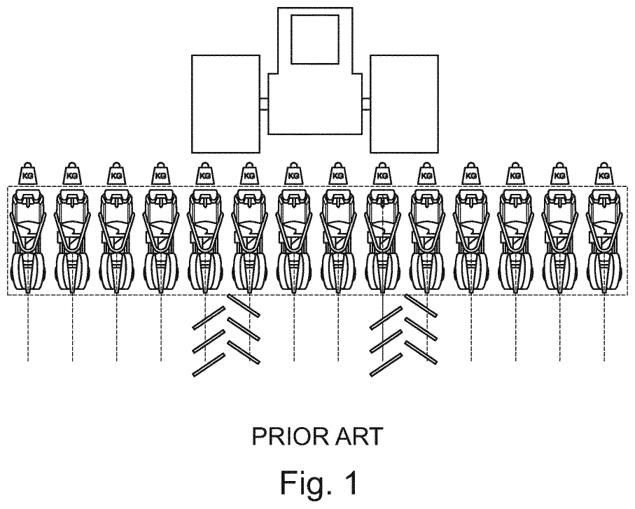

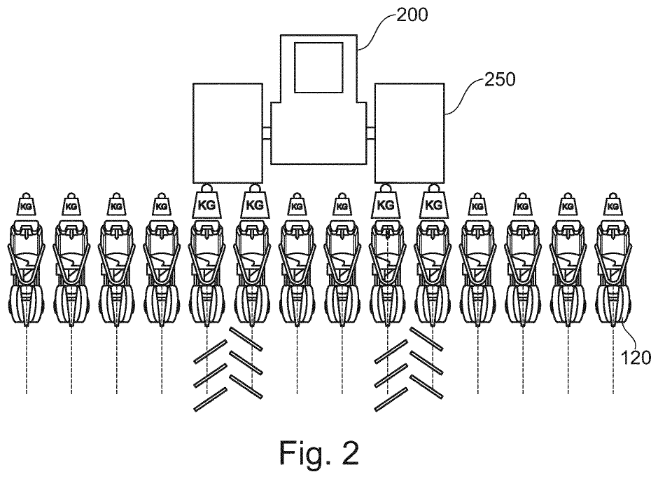

Agricultural implements such as planters generally have the same down force applied to all ground engaging tools (row units), as schematically illustrated in FIG. 1. However, not all row units are operating in the same soil conditions. Behind the tractor wheels 250 the soil is generally packed harder, since the tractor 200 has pressed it together when driving over the soil. This means that the row units will not penetrate the soil to the same depth behind the tractor wheels 250. It is therefore desirable to enable a higher down force to be applied to the row units behind the tractor wheels 250, as schematically illustrated in FIG. 2.

Prior art systems that enable different supplemental down forces to be provided to different row units are complicated and expensive, and generally enable a tailoring of an optimal down force for each row unit or group of row units, based on input from e.g. individual load sensors on each row unit. However, it is often not necessary to provide an optimal supplemental down force to each row unit—it is enough to be able to increase the supplemental down force provided to the row units behind the tractor wheels 250.

The claimed invention enables a higher supplemental down force to be applied to the row units behind the tractor wheels 250, using a fluid control system that supplies the same relation between the rod chamber control pressure and the cap chamber control pressure to all linear actuators. Embodiments of the disclosed solution are presented in more detail in connection with the figures.

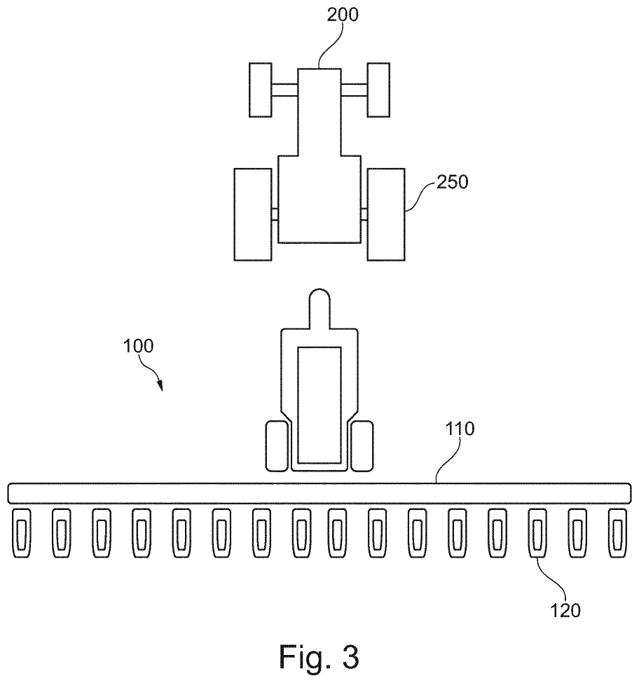

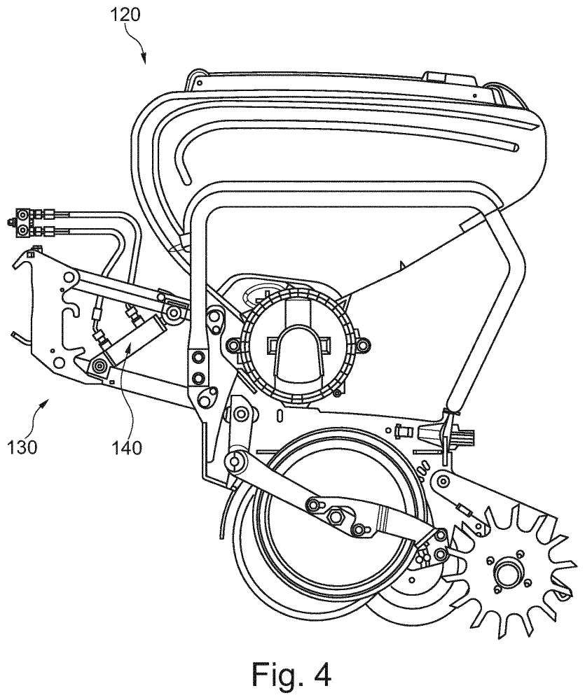

FIG. 3 schematically illustrates an agricultural implement 100 comprising an attachment frame 110 and a plurality of ground engaging tools 120, and FIG. 4 illustrates an example of a ground engaging tool 120 and a linkage arrangement 130. Preferably, each ground engaging tool 120 in FIG. 3 is connected to the attachment frame 110 via a linkage arrangement 130 such as e.g. the one illustrated in FIG. 4. For each linkage arrangement 130, there is preferably a linear actuator 140 arranged to control the pivoting of the linkage arrangement 130. Thus, for each ground engaging tool 120, there is preferably a linear actuator 140 arranged to provide a supplemental down force to the ground engaging tool 120 via the linkage arrangement 130. The agricultural implement 100 is arranged to be towed by a vehicle such as e.g. a tractor 200.

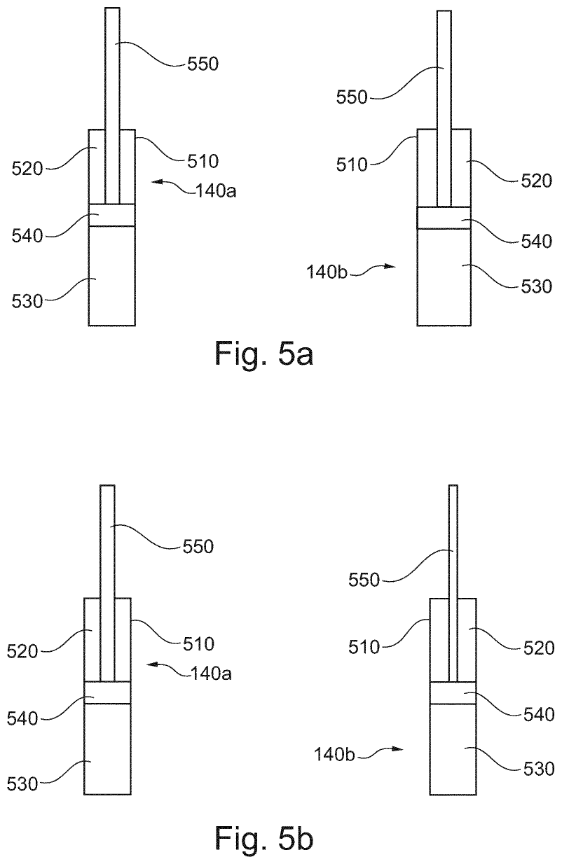

A typical linear actuator 140 comprises a barrel 510 in which two chambers, a rod chamber 520 and a cap chamber 530, are separated by a piston 540 having a connected piston rod 550 extending into the rod chamber 520 (as illustrated in FIGS. 5a-b). The movement of the piston 540 in the barrel 510 is controlled by the relation between the control pressures that are supplied to the rod chamber 520 and the cap chamber 530, creating a net force on the piston 540. If the same control pressure is supplied to both the rod chamber 520 and the cap chamber 530, there will be a resulting force on the piston 540 to move towards the rod end, since the cap chamber piston area is always larger than the rod chamber piston area (caused by there being a piston rod 550 in only the rod chamber 520). The size of this force will depend on the ratio between the rod chamber piston area and the cap chamber piston area. If a force on the piston 540 to move towards the cap end is desired, a higher control pressure must be supplied to the rod chamber 520 than to the cap chamber 530. Thus, the movement of the piston 540 can be controlled by controlling the relation between the rod chamber control pressure and the cap chamber control pressure.

The agricultural implement 100 comprises a fluid control system that is arranged to control the supplemental down force by regulating the relation between the rod chamber control pressure and the cap chamber control pressure, and thus the net force on the piston 540, for the plurality of linear actuators 140. The fluid control system may be a simple system that can only provide the same rod chamber control pressure and the same cap chamber control pressure to all of the linear actuators 140. This enables the use of a very simple fluid control system.

According to the invention, the agricultural implement 100 may comprise two different types of linear actuators 140, a first type of linear actuator 140a and a second type of linear actuator 140b, that are arranged to provide different supplemental down forces to different ground engaging tools 120. The first type of linear actuator 140a preferably has a different ratio between the rod chamber piston area and the cap chamber piston area than the second type of linear actuator 140b, creating a different net force on the piston 540 for the same relation between the rod chamber control pressure and the cap chamber control pressure. This enables a higher supplemental down force to be applied to ground engaging tools 120 arranged behind the tractor wheels 250, although the same relation between the rod chamber control pressure and the cap chamber control pressure is provided to all of the linear actuators 140.

FIGS. 5a-b schematically illustrate two different embodiments of the two different types of linear actuators 140.

In FIG. 5a, the difference between the first type of linear actuator 140a and the second type of linear actuator 140b is that the diameter of the barrel 510 in the second type of linear actuator 140b is larger than the diameter of the barrel 510 in the first type of linear actuator 140a. Thereby, both the rod chamber piston area and the cap chamber piston area will be larger in the second type of linear actuator 140b. However, the rod chamber piston area will increase more, in relation to the original rod chamber piston area, than the cap chamber piston area. The ratio between the rod chamber piston area and the cap chamber piston area will therefore be larger in the second type of linear actuator 140b than in the first type of linear actuator 140a. The same relation between the rod chamber control pressure and the cap chamber control pressure, supplied to the first type of linear actuator 140a and the second type of linear actuator 140b, will therefore cause a different net force on the piston 540 in the second type of linear actuator 140b than in the first type of linear actuator 140a.

In FIG. 5b, the difference between the first type of linear actuator 140a and the second type of linear actuator 140b is that the diameter of the piston rod 550 is smaller in the second type of linear actuator 140b than in the first type of linear actuator 140b, thereby increasing the rod chamber piston area in the second type of linear actuator 140b. The ratio between the rod chamber piston area and the rod chamber piston area will therefore be larger in the second type of linear actuator 140b than in the first type of linear actuator 140a. The same relation between the rod chamber control pressure and the cap chamber control pressure, supplied to the first type of linear actuator 140a and the second type of linear actuator 140b, will therefore cause a different net force on the piston 540 in the second type of linear actuator 140b than in the first type of linear actuator 140a.

If the linear actuators 140 are mounted as illustrated in FIG. 4, the supplemental down force is the net force pushing the piston 540 towards the cap end of the barrel 510. If the ratio between the rod chamber piston area and the cap chamber piston area is larger in the second type of linear actuator 140b than in the first type of linear actuator 140a, this means that the net force pushing the piston 540 towards the cap end of the barrel 510 will be larger in the second type of linear actuator 140b than in the first type of linear actuator 140a, if the same relation between the rod chamber control pressure and the cap chamber control pressure is supplied to the first type of linear actuator 140a and the second type of linear actuator 140b.

However, if the linear actuators are mounted so that the supplemental down force is instead the net force pushing the piston 540 towards the rod end of the barrel 510, the first type of linear actuator 140a and the second type of linear actuator 140b should be exchanged with each other, so that the ratio between the rod chamber piston area and the cap chamber piston area is instead smaller in the second type of linear actuator 140b than in the first type of linear actuator 140a.

This means that the linear actuators 140 may be adapted so that the same relation between the rod chamber control pressure and the cap chamber control pressure causes each first linear actuator 140 to provide a first supplemental down force to its ground engaging tool 120, and each second linear actuator 140 to provide a second supplemental down force to its ground engaging tool 120, where the second supplemental down force is substantially larger than the first.

This enables modification of the agricultural implement 100 by simply moving the ground engaging tools 120 and their associated linear actuators 140, or even just the linear actuators 140, to new positions on the agricultural implement. Since the same relation between the rod chamber control pressure and the cap chamber control pressure is supplied to all linear actuators 140, any linear actuator 140 can be connected in any position. The farmer simply needs to ascertain that the second linear actuators 140 are mounted behind the tractor wheels 250, in order to enable a higher down force to be applied to the ground engaging tools behind the tractor wheels 250.

For agricultural implements 100 such as agricultural planters, it is important to be able to easily adapt the number of row units 120 used, and the distance between them. Different climates and crops need different distances between the furrows, and the farmer therefore needs to be able move the row units 120 around on the attachment frame 110. Furthermore, different vehicles 200 having different widths and positions of the wheels 250 may be used on different occasions, and this also creates a need to adapt the positions of the row units 120. The described invention enables easy modification of the agricultural implement 100, since the same relation between the rod chamber control pressure and the cap chamber control pressure may be supplied to all linear actuators 140.

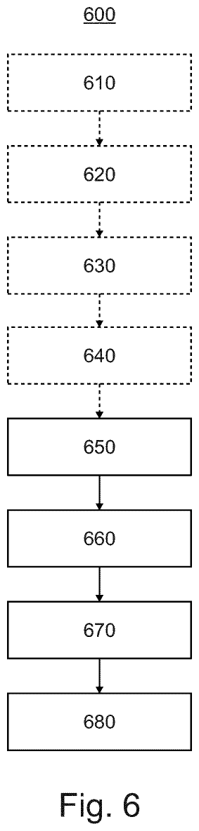

FIG. 6 schematically illustrates a method 600 for down force control in an agricultural implement 100. The method 600 may comprise:

Step 650: connecting a plurality of ground engaging tools 120 to an attachment frame 110 of an agricultural implement 100 via a linkage arrangement 130 for each ground engaging tool 120.

Step 660: for each ground engaging tool 120, arranging a linear actuator to control the pivoting of the linkage arrangement 130, so that there for each ground engaging tool 120 is a linear actuator 140 arranged to provide a supplemental down force to the ground engaging tool 120 via the linkage arrangement 130, where each linear actuator 140 comprises a barrel 510, divided into a rod chamber 520 and a cap chamber 530 by a piston 540 with a connected piston rod 550 extending into the rod chamber 520, the piston 540 having a rod chamber piston area and a cap chamber piston area.

Step 670: arranging a fluid control system to control the size of the supplemental down force in each of the plurality of linear actuators 140 by regulating the relation between a rod chamber control pressure supplied to the rod chamber 520 and a cap chamber control pressure supplied to the cap chamber 530, creating a net force on the piston 540.

Step 680: arranging the linear actuators 140 to comprise first linear actuators 140a and second linear actuators 140b, adapted so that the same relation between the rod chamber control pressure and the cap chamber control pressure causes each first linear actuator 140a to provide a first supplemental down force to its ground engaging tool 120, and each second linear actuator 140b to provide a second supplemental down force to its ground engaging tool 120, where the second supplemental down force is substantially larger than the first.

This enables different ground engaging tools to exert different down forces towards the ground using a fluid control system that supplies the same relation between the rod chamber control pressure and the cap chamber control pressure to all linear actuators.

In embodiments, the agricultural implement 100 is an agricultural planter, and the ground engaging tools 120 are row units.

In embodiments, the method 600 further comprises at least one of the following:

Step 610: arranging the ratio between the rod chamber piston area and the cap chamber piston area to be different in the first linear actuators 140a than in the second linear actuators 140b.

Step 620: arranging the diameter of barrel 510 in the first linear actuators 140a to be substantially different from the diameter of the barrel 510 in the second linear actuators 140b. This is one simple way of ensuring that the ratio between the cap chamber piston area and the rod chamber piston area is different in the first linear actuators 140a than in the second linear actuators 140b. In embodiments, the diameter of the barrel 510 in the second linear actuators 140b is arranged to be substantially larger than the diameter of the barrel 510 in the first linear actuators 140a.

Step 630: arranging the diameter of the piston rod 550 in the second linear actuators 140b to be substantially different from the diameter of the piston rod 550 in the first linear actuators 140a. This is another simple way of ensuring that the ratio between the cap chamber piston area and the rod chamber piston area is different in the first linear actuators 140a than in the second linear actuators 140b. In embodiments, the diameter of the piston rod 550 in the second linear actuators 140b is arranged to be substantially smaller than the diameter of the piston rod 550 in the first linear actuators 140a.

Step 640: arranging the second linear actuators 140b in positions where a substantially higher supplemental down force is desired, such as in positions that are expected to be located behind wheels 250 of a vehicle 200 towing the agricultural implement 100.

This enables modification of the agricultural implement 100 by simply moving the ground engaging tools 120 and their associated linear actuators 140 to new positions on the agricultural implement. Since the same relation between the rod chamber control pressure and the cap chamber control pressure is supplied to all linear actuators 140, any linear actuator 140 can be connected in any position. The farmer simply needs to ascertain that the second linear actuators 140 are mounted behind the tractor wheels 250, in order to enable a higher down force to be applied to the ground engaging tools behind the tractor wheels 250.

The fluid control system may be controlled by a control system in the vehicle 200 towing the agricultural implement 100. The fluid control system may even be connected to a fluid supply in the towing vehicle 200.

The control system may e.g. be a general control system in the vehicle 200 pulling the agricultural implement 100, that the farmer may use to control all aspects of operation of the agricultural implement 100. There may e.g. be a control pad arranged in front of the driver's seat, and commands may be input into the control system using this control pad.

The farmer may e.g. upon inspection decide that insufficient force has been exerted by the ground engaging tools 120 towards the ground. The farmer may then input into the control system that the force exerted by the ground engaging tools 120 towards the ground should be increased by e.g. 10%. The control system will then automatically determine how the relation between the rod chamber control pressure and the cap chamber control pressure should be adjusted to increase the force exerted by the ground engaging tool 120 towards the ground by 10%, and provide the fluid control system with a control signal indicating the new desired rod chamber control pressure and cap chamber control pressure. This enables an easy adjustment of the force exerted by ground engaging tools 120 towards the ground.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Further, not all of the steps of the claims have to be carried out in the listed order. All technically meaningful orders of the steps are covered by the claims. Accordingly, the scope of the invention is defined only by the claims.

1. An agricultural implement comprising:
an attachment frame;
a plurality of ground engaging tools, each connected to the attachment frame via a linkage arrangement;
a plurality of linear actuators, each comprising a barrel, divided into a rod chamber and a cap chamber by a piston with a connected piston rod extending into the rod chamber, the piston having a rod chamber piston area and a cap chamber piston area; and
a fluid control system,
wherein:
each linear actuator is arranged to control the pivoting of one of the linkage arrangements, so that, for each ground engaging tool, there is a linear actuator arranged to provide a supplemental down force to the ground engaging tool via the linkage arrangement;
the fluid control system is arranged to control the size of the supplemental down force provided by each of the plurality of linear actuators by regulating the relation between a rod chamber control pressure supplied to the rod chamber and a cap chamber control pressure supplied to the cap chamber, creating a net force on the piston; and
the plurality of linear actuators comprises first linear actuators and second linear actuators, adapted so that the same relation between the rod chamber control pressure and the cap chamber control pressure causes each first linear actuator to provide a first supplemental down force to its ground engaging tool, and each second linear actuator to provide a second supplemental down force to its ground engaging tool, where the second supplemental down force is substantially larger than the first.

2. The agricultural implement according to claim 1, wherein the ratio between the cap chamber piston area and the rod chamber piston area in the second linear actuators is substantially different from the ratio between the cap chamber piston area and the rod chamber piston area in the first linear actuators.

3. The agricultural implement according to claim 1, wherein the diameter of the barrel in the second linear actuators is substantially different from the diameter of the barrel in the first linear actuators.

4. The agricultural implement according to claim 3, wherein the diameter of the barrel in the second linear actuators is substantially larger than the diameter of the barrel in the first linear actuators.

5. The agricultural implement according to claim 1, wherein the diameter of the piston rod in the second linear actuators is substantially different from the diameter of the piston rod in the first linear actuators.

6. The agricultural implement according to claim 5, wherein the diameter of the piston rod in the second linear actuators is substantially smaller than the diameter of the piston rod in the first linear actuators.

7. The agricultural implement according to claim 1, wherein the second linear actuators are arranged in positions where a substantially higher supplemental down force is desired, such as in positions that are expected to be located behind wheels of a vehicle towing the agricultural implement.

8. The agricultural implement according to claim 1, wherein the agricultural implement is an agricultural planter, and the ground engaging tools are row units.

9. A method for down force control in an agricultural implement, the method comprising:
connecting a plurality of ground engaging tools to the attachment frame of an agricultural implement via a linkage arrangement for each ground engaging tool; and
for each ground engaging tool, arranging a linear actuator to control the pivoting of the linkage arrangement, so that, for each ground engaging tool, there is a linear actuator arranged to provide a supplemental down force to the ground engaging tool via the linkage arrangement, where each linear actuator comprises a barrel, divided into a rod chamber and a cap chamber by a piston with a connected piston rod extending into the rod chamber, the piston having a rod chamber piston area and a cap chamber piston area;
arranging a fluid control system to control the size of the supplemental down force in each of the plurality of linear actuators by regulating the relation between a rod chamber control pressure supplied to the rod chamber and a cap chamber control pressure supplied to the cap chamber, creating a net force on the piston; and
arranging the linear actuators to comprise first linear actuators and second linear actuators, adapted so that the same relation between the rod chamber control pressure and the cap chamber control pressure causes each first linear actuator to provide a first supplemental down force to its ground engaging tool, and each second linear actuator to provide a second supplemental down force to its ground engaging tool, where the second supplemental down force is substantially larger than the first.

10. The method according to claim 9, further comprising arranging the ratio between the cap chamber piston area and the rod chamber piston area in the second linear actuators to be substantially different from the ratio between the cap chamber piston area and the rod chamber piston area in the first linear actuators.

11. The method according to claim 9, further comprising arranging the diameter of the barrel in the second linear actuators to be substantially different from the diameter of the barrel in the first linear actuators.

12. The method according to claim 11, further comprising arranging the diameter of the barrel in the second linear actuators to be substantially larger than the diameter of the barrel in the first linear actuators.

13. The method according to claim 9, further comprising arranging the diameter of the piston rod in the second linear actuators to be substantially different from the diameter of the piston rod in the first linear actuators.

14. The method according to claim 13, further comprising arranging the diameter of the piston rod in the second linear actuators to be substantially smaller than the diameter of the piston rod in the first linear actuators.

15. The method according to claim 9, further comprising arranging the second linear actuators in positions where a substantially higher supplemental down force is desired, such as in positions that are expected to be located behind wheels of a vehicle towing the agricultural implement.

16. The method according to claim 9, wherein the agricultural implement is an agricultural planter, and the ground engaging tools are row units.
